(19) United States
(12) Patent Application Publication
(10) Pub. No.: US 2025/0181971 A1
(43) Pub. Date: Jun. 5, 2025

(54) MODEL LEARNING APPARATUS, SECURE FEDERATED LEARNING APPARATUS, THEIR METHODS, AND PROGRAMS

(71) Applicant: NIPPON TELEGRAPH AND TELEPHONE CORPORATION, Tokyo (JP)

(72) Inventors: Iifan TYOU, Tokyo (JP); Gembu MOROHASHI, Tokyo (JP); Takumi FUKAMI, Tokyo (JP)

(73) Assignee: NIPPON TELEGRAPH AND TELEPHONE CORPORATION, Tokyo (JP)

(21) Appl. No.: 18/842,034

(22) PCT Filed: Mar. 31, 2022
(86) PCT No.: PCT/JP2022/016500

§ 371 Date: Aug. 27, 2024

(51) Int. Cl. G06N 20/00

(52) U.S. Cl. CPC G06N 20/00

(57) ABSTRACT

A model learning device obtains information that specifies an aggregate model or confidential information of the information that specifies the aggregate model from a secure federated learning device, updates the aggregate model through machine learning using local learning data to obtain a worker model, and obtains and provides confidential information of information that specifies the worker model to the secure federated learning device. A secure federated learning device obtains confidential information of information that specifies a plurality of worker models from a plurality of model learning devices, and obtains and provides, to the plurality of model learning devices, confidential information of information that specifies an aggregate model that is an aggregation of the plurality of worker models without obtaining the plurality of worker models through secure computation using the obtained confidential information.

### TECHNICAL FIELD

The present invention relates to machine learning technology, and particularly to federated learning technology.

### BACKGROUND ART

Federated learning is known in which machine learning is performed in a distributed state without aggregating learning data (see, for example, NPL 1). In federated learning, a plurality of model learning devices generate worker models (local models) by performing machine learning using learning data that they hold, and transmit the generated worker models to a federated learning device. The federated learning device generates an aggregate model (global model) that is an aggregation of worker models sent from the plurality of model learning devices, and transmits the generated aggregate model to the plurality of model learning devices. The plurality of model learning devices that have received the aggregate model update the aggregate model through machine learning using learning data that they hold, generate new worker models, and transmit the generated worker models to the federated learning device. By repeating such processing, each model learning device can obtain an aggregate model in which learning data held in a plurality of model learning devices is reflected in machine learning, without passing the learning data that it holds to the outside.

### CITATION LIST

### Non Patent Literature

[NPL 1] C. He, S. Li, J. So, X. Zeng, M. Zhang, etc, “FedML: A Research Library and Benchmark for Federated Machine Learning,” [online], Jan. 27, 2020, arXiv: 2007.13518, [Retrieved on Feb. 17, 2022], Internet <https://arxiv.org/abs/2007.13518>

### SUMMARY OF INVENTION

### Technical Problem

However, in conventional federated learning, the federated learning device receives plain text worker models from each model learning device. Therefore, the federated learning device can know the tendency of the learning data held by each model learning device on the basis of the difference between the transmitted aggregate model and the received worker model.

The present invention has been made in view of these points, and an object of the present invention is to improve the safety of federated learning.

### Solution to Problem

A model learning device obtains information that specifies an aggregate model or confidential information of the information that specifies the aggregate model from a secure federated learning device, updates the aggregate model through machine learning using local learning data stored in a storage unit to obtain a worker model, obtains confidential information of information that specifies the worker model, and provides the confidential information of the information that specifies the worker model to the secure federated learning device.

A secure federated learning device obtains confidential information of information that specifies a plurality of worker models from a plurality of model learning devices, obtains confidential information of information that specifies an aggregate model that is an aggregation of the plurality of worker models without obtaining the plurality of worker models through secure computation using the confidential information of the information that specifies the plurality of worker models, and provides the information that specifies the aggregate model or the confidential information of the information that specifies the aggregate model to the plurality of model learning devices.

### Advantageous Effects of Invention

Thereby, the safety of federated learning can be improved.

### BRIEF DESCRIPTION OF DRAWINGS

FIG. 1 is a block diagram illustrating a configuration of a federated learning system according to first and second embodiments.

FIG. 2 is a block diagram illustrating a configuration of a model learning device according to first and second embodiments.

FIG. 3 is a block diagram illustrating a configuration of a secure federated learning device according to first, third, and fourth embodiments.

FIG. 4 is a block diagram illustrating a configuration of a secure federated learning device according to second, third, and fourth embodiments.

FIG. 5 is a block diagram illustrating a configuration of a federated learning system according to third and fourth embodiments.

FIG. 6 is a block diagram illustrating a configuration of a model learning device according to third and fourth embodiments.

FIG. 7 is a block diagram illustrating a hardware configuration of an embodiment.

### DESCRIPTION OF EMBODIMENTS

Embodiments of the present invention will be described below with reference to the drawings.

### First Embodiment

In the present embodiment, among functions of a federated learning device, collection of worker models (local models) and generation of aggregate models are performed in a secure state.

### <Configuration>

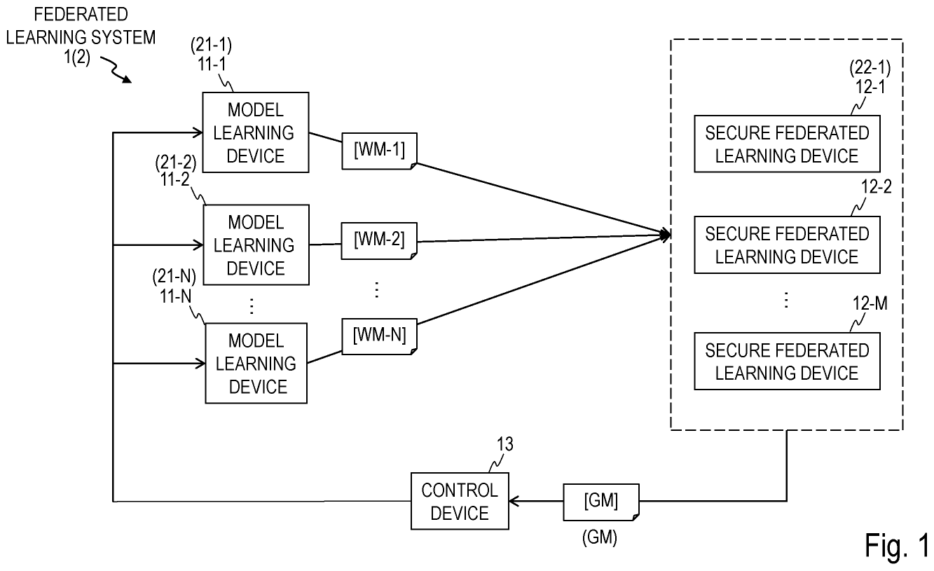

As illustrated in FIG. 1, a federated learning system 1 of the present embodiment includes N model learning devices 11-1, . . . 11-N that perform model learning, M secure federated learning devices 12-1, . . . , 12-M that perform federated learning through secure computation, and a control device 13 that controls federated learning. There are no limitations to the secure computation method. For example, this secure computation method may be a multi-party computation method of performing secure computation using shares obtained by secret sharing, or may be a homomorphic encryption method of performing secure computation using homomorphic encryption. N is an integer of 1 or more, for example, N is an integer of 2 or more. M is an integer of 1 or more, for example, M is an integer of 2 or more. Here, when the secure computation method is a multi-party computation method, M is an integer of 2 or more. When the secure computation method is a homomorphic encryption method, M is an integer of 1 or more, for example, M=1.

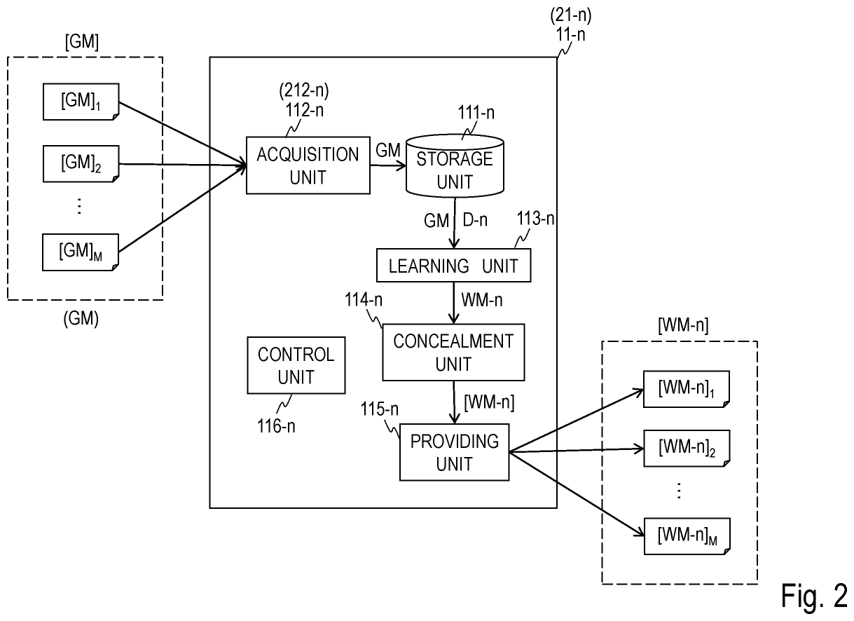

As illustrated in FIG. 2, a model learning device 11-n of the present embodiment includes a storage unit 111-n, an acquisition unit 112-n, a learning unit 113-n, a concealment unit 114-n, a providing unit 115-n, and a control unit 116-n. The model learning device 11-n executes each process on the basis of the control of the control unit 116-n, and input information and information obtained through each process are stored in the storage unit 111-n, and read and used as necessary. Here, n is a positive integer, and n=1, . . . , N. Unless otherwise specified, the configuration and processing regarding n are the same for all n=1, . . . , N. However, the content of the data (information) handled may differ depending on the value of n.

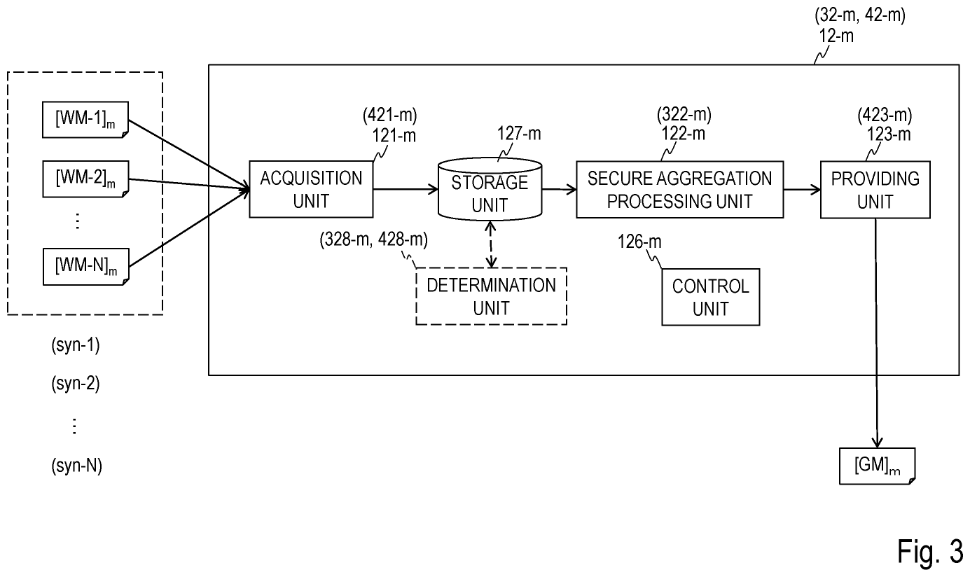

As illustrated in FIG. 3, a secure federated learning device 12-m of the present embodiment includes an acquisition unit 121-m, a secure aggregation processing unit 122-m, a providing unit 123-m, a control unit 126-m, and a storage unit 127-m. The secure federated learning device 12-m executes each process on the basis of the control of the control unit 126-m, and input information and information obtained through each process are stored in the storage unit 127-m, and read and used as necessary. Here, m is a positive integer, and m=1, . . . , M. Unless otherwise specified, the configuration and processing regarding m are the same for all m=1, . . . , M. However, the content of the data (information) handled may differ depending on the value of m.

### <Preprocessing>

Local learning data D-n of each model learning device 11-n is stored in the storage unit 111-n of the model learning device 11-n. The local learning data D-n is learning data for machine learning, and may be learning data for supervised learning or learning data for unsupervised learning. Furthermore, the local learning data D-n may be updated. Further, when the secure computation method used is a homomorphic encryption method, the storage unit 111-n of the model learning device 11-n stores an encryption key and a decryption key.

### <Learning Processing>

The learning processing of the present embodiment will be illustrated below.

The learning unit 113-n of each model learning device 11-n (FIG. 2) reads the local learning data D-n stored in the storage unit 111-n, updates the latest aggregate model through machine learning using the local learning data D-n to obtain a worker model, and outputs information WM-n (for example, a model parameter group) that specifies the worker model. When the model learning device 11-n has not yet obtained an aggregate model, the initialized machine learning model is the “latest aggregate model.” An initialized machine learning model may be provided from the control device 13. The initialized model is, for example, a machine learning model in which an initial model parameter group is set. When the model learning device 11-n has obtained information GM that specifies an aggregate model as will be described later, the latest one among the aggregate models specified by the information GM is the “latest aggregate model.” In the latter case, the learning unit 113-n specifies the latest aggregate model on the basis of the information GM read from the storage unit 111-n. Note that the aggregate model and worker model are known machine learning models. The aggregate model and worker model are not limited, and may be, for example, a model based on a deep learning method or a model based on a hidden Markov model method, a model based on a support vector machine method, or a model based on linear prediction. Here, all aggregate models and worker models handled by the federated learning system 1 are models based on the same method. Information WM-n that specifies the worker model is sent to the concealment unit 114-n (step S113-n).

Information WM-n that specifies the worker model is input to the concealment unit 114-n. The concealment unit 114-n conceals the information WM-n that specifies the worker model using a method that allows the above-mentioned secure computation, and obtains and outputs confidential information [WM-n] of the information WM-n that specifies the worker model. For example, when the above-mentioned secure computation method is a multi-party computation method, the concealment unit 114-n secretly shares the information WM-n among M pieces and obtains M shares [WM-n]₁, . . . , [WM-n]_{M} and outputs them as confidential information [WM-n]. For example, when the above-mentioned secure computation method is a homomorphic encryption method, the concealment unit 114-n uses the encryption key read from the storage unit 111-n to encrypt the information WM-n according to the homomorphic encryption method to obtain M (for example, one) ciphertexts [WM-n]₁, [WM-n]_{M}, and outputs the ciphertexts [WM-n]₁, . . . , [WM-n]_{M} as confidential information [WM-n]. The confidential information [WM-n]={[WM-n]₁, . . . , [WM-n]_{M}} is sent to the providing unit 115-n (step S114-n).

Confidential information [WM-n]={[WM-n]₁, . . . , [WM-n]_{M}} of information WM-n that specifies a worker model is input to the providing unit 115-n. The providing unit 115-n transmits (provides) confidential information [WM-n]m of the information WM-n that specifies the worker model to the secure federated learning device 12-m (FIG. 3) (where m=1, . . . , M). Further, the providing unit 115-n sends, to the control device 13, synchronization information that the model learning device 11-n has transmitted the confidential information [WM-n]ₘ to the secure federated learning device 12-m (that the model learning device 11-n has finished learning the worker model and has transmitted the confidential information [WM-n]ₘ of the information WM-n that specifies the worker model to the secure federated learning device 12-m) (step S115-n).

The acquisition unit 121-m of the secure federated learning device 12-m (FIG. 3) receives the confidential information [WM-n]ₘ of the information WM-n that specifies the worker model sent from the model learning device 11-n, and stores the confidential information [WM-n]ₘ in the storage unit 127-m. That is, the acquisition unit 121-m obtains the confidential information [WM-n]ₘ of the information WM-n that specifies a plurality of worker models from a plurality of model learning devices 11-n and stores the confidential information [WM-n]ₘ in the storage unit 127-m (step S121-m).

Based on the synchronization information, the control device 13 determines whether or not all model learning devices 11-1, . . . 11-N have transmitted confidential information [WM-n]₁, . . . , [WM-n]_{M} to all secure federated learning devices 12-1, . . . 12-M (step S131). Here, when it is determined that not all model learning devices 11-n (where n=1, . . . , N) have transmitted confidential information [WM-n]₁, . . . , [WM-n]_{M} to all secure federated learning devices 12-1, 12-M, and it is determined that a predetermined time has not elapsed from a reference point of time (timeout has not occurred), the control device 13 performs the determination in step S131 at certain intervals. On the other hand, when it is determined that all model learning devices 11-n (where n=1, . . . , N) have transmitted confidential information [WM-n]₁, . . . , [WM-n]_{M} to all secure federated learning devices 12-1, 12-M, or it is determined that a predetermined time has elapsed from the reference point of time (timeout has occurred), the control device 13 sends a command to instruct the secure federated learning devices 12-1, . . . , 12-M to start secure aggregation processing. Note that the reference point of time for the above-mentioned timeout may be any value; for example, the reference point of time may be the start or end time of the previous secure aggregation processing, or the start time of the learning processing if the secure aggregation processing has not been executed yet (step S132).

The command to instruct the start of secure aggregation processing is received by the acquisition unit 121-m of the secure federated learning device 12-m (where m=1, . . . , M) (FIG. 3), and is input to the control unit 126-m. Upon receiving the command to instruct the start of the secure aggregation processing, the control unit 126-m instructs the secure aggregation processing unit 122-m to start the secure aggregation processing. Upon receiving this, the secure aggregation processing unit 122-m reads a plurality of pieces of confidential information [WM-n] (where n∈{1, . . . , N}) (confidential information of information that specifies a plurality of worker models) from the storage unit 127-m, and obtains and outputs confidential information [GM]ₘ of information GM that specifies an aggregate model that is an aggregation of the plurality of worker models without obtaining the plurality of worker models through secure computation using the read information (secure aggregation processing). For example, when the information WM-n that specifies the worker model is a model parameter group {P₁(n), . . . , P_{K}(n)} of the worker model, a model parameter group {p₁, . . . , pₖ} that is an aggregation of model parameter groups {p₁(n₁), . . . , pₖ(n₁)}, {p₁(nₘₐₓ), . . . , pₖ(nₘₐₓ)} for {n₁, . . . , nₘₐₓ}⊆{1, . . . , N} becomes information GM that specifies the aggregate model. For example, pₖ is a function value such as a weighted linear combination value or an average value of pₖ(n₁), . . . , pₖ(nₘₐₓ). Here, k is an index k=1, . . . , K that identifies model parameters, and K is a positive integer. The secure aggregation processing unit 122-m obtains and outputs the confidential information [GM]ₘ of the information GM that specifies the aggregate model through secure computation without restoring the information WM-n that specifies the worker model or the information GM that specifies the aggregate model. The confidential information [GM]ₘ of the information GM that specifies the aggregate model is sent to the providing unit 123-m (step S122-m).

Confidential information [GM]ₘ is input to the providing unit 123-m. The providing unit 123-m transmits (provides) the confidential information [GM]ₘ to the plurality of model learning devices 11-n (where n∈{1, . . . , N}) via the control device 13. For example, the providing unit 123-m transmits (provides) the confidential information [GM]ₘ to all the model learning devices 11-1, . . . , 11-N via the control device 13 (step S123-m).

The acquisition unit 112-n of the model learning device 11-n (FIG. 2) to which the confidential information [GM]ₘ (where m∈{1, . . . , M}) is sent receives the confidential information [GM]ₘ (the confidential information of the information GM that specifies the aggregate model provided from the secure federated learning device 12-m). The acquisition unit 112-n restores the confidential information [GM]ₘ and obtains information GM that specifies the aggregate model. For example, when the secure computation method is a multi-party computation method, the acquisition unit 112-n restores the information GM from a plurality of pieces of mutually different confidential information [GM]ₘ₍₁₎, [GM]ₘ₍ₘₐₓ₎ (where {m(1), . . . , m(max)}⊆{1, . . . , M}) required for restoration. When the secure computation method is a homomorphic encryption method, the acquisition unit 112-n decrypts the confidential information [GM]ₘ using the decryption key read from the storage unit 111-n to obtain information GM. The information GM that specifies the aggregate model is stored in the storage unit 111-n (step S112-n).

The control unit 116-n determines whether or not a termination condition for federated learning is satisfied (step S116-n). Here, when the termination condition is not satisfied, the process returns to step S113-n. In this case, the processes from step S113-n to step S116-n described so far (that is, S113-n, S114-n, S115-n, S121-m, S131, S132, S122-m, S123-m, S112-n, S116-n) are executed again. On the other hand, when the termination condition is satisfied, the process is terminated. Note that any termination conditions may be used. For example, the termination condition may be that the control device 13 transmits a command to the model learning device 11-n to terminate federated learning when the number of updates, amount of updates, update time, and the like of the aggregate model have reached a specified value, and receives this command. Alternatively, the control unit 116-n may determine whether or not the number of updates, amount of updates, update time, and the like of the aggregate model have reached a specified value, and may set reaching the specified value as the termination condition.

### Features of Present Embodiment

In the present embodiment, a plurality of model learning devices provide confidential information of information that specifies worker models to a secure federated learning device, and the secure federated learning device obtains confidential information of information that specifies an aggregate model that is an aggregation of the plurality of worker models without obtaining the plurality of worker models using the confidential information. In this case, since the secure federated learning device cannot obtain the worker model itself, the tendency of learning data held by each model learning device cannot be known on the basis of the difference between the worker model and the aggregate model. Thereby, the safety of federated learning can be improved.

### Modification 1 of First Embodiment

Based on the synchronization information, the control device 13 has determined whether or not all model learning devices 11-1, . . . , 11-N have transmitted confidential information [WM-n]₁, . . . , [WM-n]_{M} to all secure federated learning devices 12-1, . . . , 12-M (step S131). However, this does not limit the present invention. For example, instead of this, it may be determined whether or not a predetermined number of model learning devices have transmitted confidential information to a predetermined number of secure federated learning devices. When it is determined that a predetermined number of model learning devices have not transmitted confidential information to a predetermined number of secure federated learning devices and a predetermined time has not elapsed from a reference point of time, the control device 13 may perform this determination at certain intervals, and when it is determined that a predetermined number of model learning devices have transmitted confidential information to a predetermined number of secure federated learning devices or a predetermined time has elapsed from a reference point of time, the control device 13 may send a command to instruct the secure federated learning devices 12-1, . . . , 12-M to start secure aggregation processing. Alternatively, when a predetermined time has simply elapsed from the reference point of time, the control device 13 may send a command to instruct the secure federated learning devices 12-1, . . . , 12-M to start the secure aggregation processing.

### Second Embodiment

The present embodiment is a modification of the first embodiment or Modification 1 of the first embodiment, and employs an aspect in which a specific secure federated learning device 12-1 restores information GM that specifies an aggregate model from confidential information [GM]₁, . . . , [GM]_{M}, and provides the information GM that specifies the aggregate model to each model learning device 11-n. Hereinafter, the description will focus on the differences from the matters described so far, and the same reference numbers will be used for the matters already described to simplify the description.

### <Configuration>

As illustrated in FIG. 1, a federated learning system 2 of the present embodiment includes N model learning devices 21-1, 21-N that perform model learning, M secure federated learning devices 22-1, 12-2, . . . , 12-M that perform federated learning through secure computation, and a control device 13 that controls federated learning.

As illustrated in FIG. 2, a model learning device 21-n of the present embodiment includes a storage unit 111-n, an acquisition unit 212-n, a learning unit 113-n, a concealment unit 114-n, a providing unit 115-n, and a control unit 116-n. The model learning device 21-n executes each process on the basis of the control of the control unit 116-n, and input information and information obtained through each process are stored in the storage unit 111-n, and read and used as necessary.

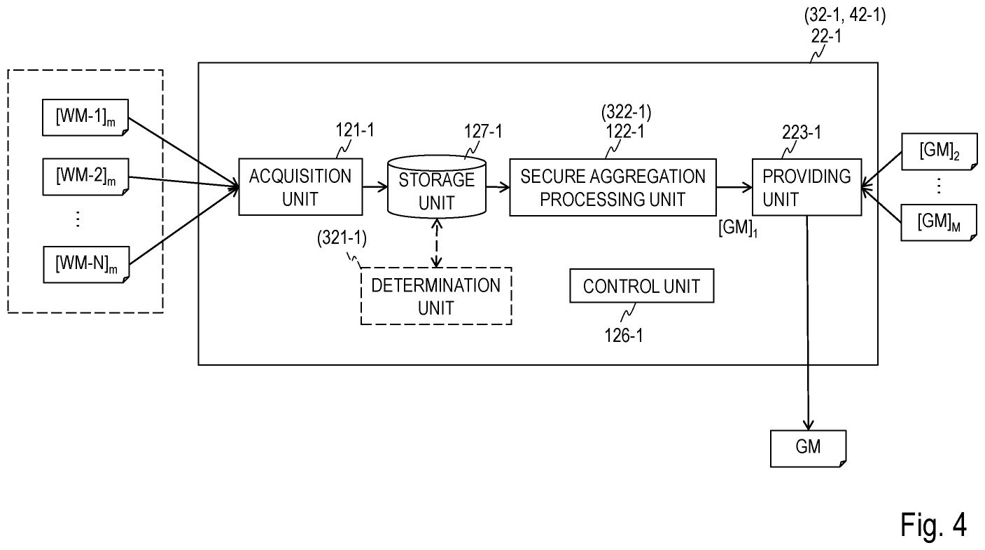

As illustrated in FIG. 4, a secure federated learning device 22-1 of the present embodiment includes an acquisition unit 121-1, a secure aggregation processing unit 122-1, a providing unit 223-1, a control unit 126-1, and a storage unit 127-1. The secure federated learning device 22-1 executes each process on the basis of the control of the control unit 126-1, and input information and information obtained through each process are stored in the storage unit 127-1, and read and used as necessary. The configurations of the secure federated learning devices 12-2, . . . , 12-M are the same as in the first embodiment.

### <Preprocessing>

The preprocessing of the present embodiment is the same as the first embodiment except that the decryption key is stored in the storage unit 127-1 of the secure federated learning device 22-1 instead of the storage unit 111-n of the model learning device 11-n when the secure computation method used is a homomorphic encryption method.

### <Learning Processing>

The learning processing of the present embodiment will be illustrated below.

First, the model learning device 21-n instead of the model learning device 11-n executes the processes of steps S113-n, S114-n, and S115-n described in the first embodiment, the secure federated learning device 22-1 instead of the secure federated learning device 12-1 executes the process of step S121-1, a secure federated learning device 12-m′ (where m′∈{2, . . . , M}) executes the process of step S121-m′, the control device 13 executes the processes of steps S131 and S132, the secure federated learning device 22-1 instead of the secure federated learning device 12-1 executes the process of step S122-1, and the secure federated learning device 12-m′ (where m′∈{2, . . . , M}) executes the process of step S122-m′. However, in step S122-1, the confidential information [GM]₁ of the information GM that specifies the aggregate model is sent to the providing unit 223-1 of the secure federated learning device 22-1 (FIG. 4) instead of the providing unit 123-1 of the secure federated learning device 12-1. Furthermore, in the case of M≥2, the providing unit 123-m′ (where m′∈{2, . . . , M}) of the secure federated learning device 12-m′ further transmits confidential information [GM]ₘ′ to the providing unit 223-1 of the secure federated learning device 22-1 (FIG. 4). Thus, the confidential information [GM]ₘ (where m∈{1, . . . , M}) is input to the providing unit 223-1 of the secure federated learning device 22-1. The providing unit 223-1 restores the input confidential information [GM]ₘ to obtain information GM that specifies the aggregate model. For example, when the secure computation method is a multi-party computation method, the providing unit 223-1 restores the information GM from a plurality of pieces of mutually different confidential information [GM]ₘ₍₁₎, [GM]ₘ₍ₘₐₓ₎ (where {m(1), . . . , m(max)}⊆{1, . . . , M}) required for restoration. When the secure computation method is a homomorphic encryption method, the providing unit 223-1 decrypts the confidential information [GM]ₘ using the decryption key read from the storage unit 127-1 to obtain information GM. The providing unit 223-1 transmits (provides) the information GM to the plurality of model learning devices 21-n (where n∈{1, . . . , N}) via the control device 13. For example, the providing unit 223-1 transmits (provides) the information GM to all the model learning devices 21-1, . . . , 21-N via the control device 13 (step S223-1).

The acquisition unit 212-n of the model learning device 21-n (FIG. 2) to which the information GM has been sent receives the information GM (information that specifies the aggregate model). That is, the acquisition unit 212-n obtains the information GM that specifies the aggregate model from the secure federated learning device 12-1. The information GM that specifies this aggregate model is stored in the storage unit 111-n (step S212-n). The control unit 116-n determines whether or not a termination condition for federated learning is satisfied (step S116-n). Here, when the termination condition is not satisfied, the process returns to step S113-n. In this case, the processes from step S113-n to step S116-n described so far (that is, S113-n, S114-n, S115-n, S121-m, S131, S132, S122-m, S223-1, S212-n, S116-n) are executed again. On the other hand, when the termination condition is satisfied, the process is terminated. Other matters are as described in the first embodiment. Further, in the second embodiment, the same modification as Modification 1 of the first embodiment may be performed.

### Features of Present Embodiment

Also in the present embodiment, a plurality of model learning devices provide confidential information of information that specifies worker models to a secure federated learning device, and the secure federated learning device obtains confidential information of information that specifies an aggregate model that is an aggregation of the plurality of worker models without obtaining the plurality of worker models using the confidential information. In this case, since the secure federated learning device cannot obtain the worker model itself, the tendency of learning data held by each model learning device cannot be known on the basis of the difference between the worker model and the aggregate model. Thereby, the safety of federated learning can be improved.

### Third Embodiment

The present embodiment is a modification of the first embodiment. In a third embodiment, the model learning device determines whether or not it is necessary to update the acquired aggregate model to newly obtain a worker model. When it is determined that it is necessary to update the acquired aggregate model to newly obtain a worker model, the model learning device updates the aggregate model to newly obtain the worker model, but when it is determined that it is not necessary to update the acquired aggregate model to newly obtain a worker model, the model learning device acquires confidential information of information that specifies a new aggregate model from the secure federated learning device after a waiting time has elapsed without updating the aggregate model to newly obtain a worker model. Further, in the third embodiment, the secure federated learning device determines whether or not the confidential information of the information that specifies the worker model has been obtained from a predetermined model learning device. When it is determined that the confidential information of the information that specifies the worker model has been obtained from the predetermined model learning device, the secure federated learning device obtains confidential information of information that specifies an aggregate model that is an aggregation of worker models through secure computation using the confidential information of the information that specifies the worker model. Thereby, the safety of federated learning can be improved without using the control device 13.

### <Configuration>

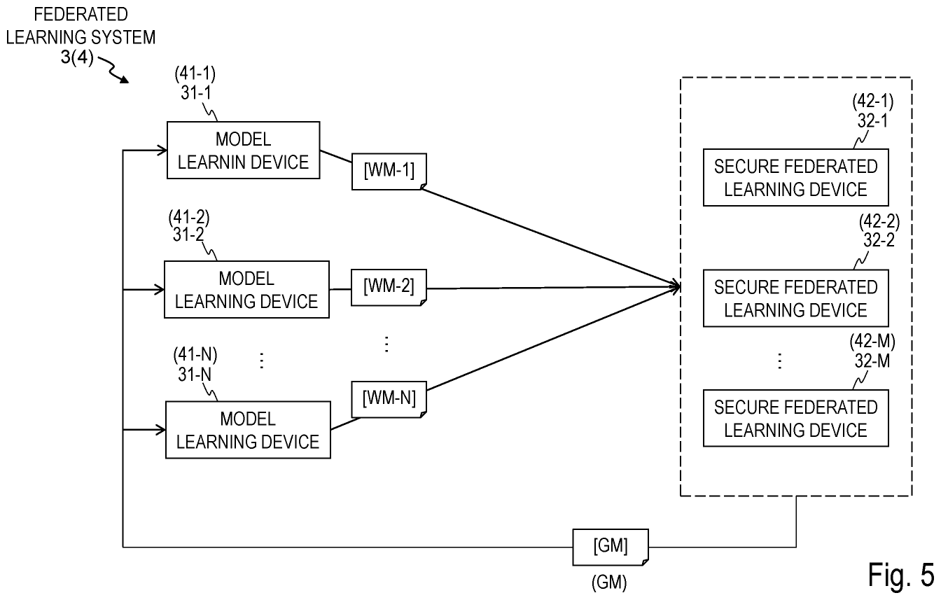

As illustrated in FIG. 5, a federated learning system 3 of the present embodiment includes N model learning devices 31-1, 31-N that perform model learning and M secure federated learning devices 32-1, . . . , 32-M that perform federated learning through secure computation.

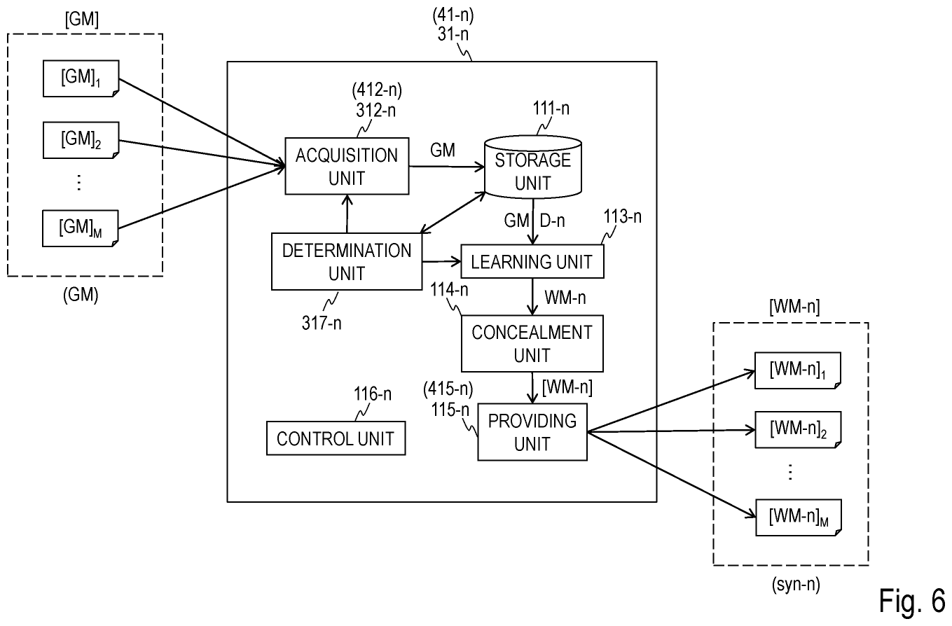

As illustrated in FIG. 6, a model learning device 31-n of the present embodiment includes a storage unit 111-n, an acquisition unit 312-n, a determination unit 317-n, a learning unit 113-n, a concealment unit 114-n, a providing unit 115-n, and a control unit 116-n. The model learning device 31-n executes each process on the basis of the control of the control unit 116-n, and input information and information obtained through each process are stored in the storage unit 111-n, and read and used as necessary.

As illustrated in FIG. 3, a secure federated learning device 32-m of the present embodiment includes an acquisition unit 121-m, a determination unit 328-m, a secure aggregation processing unit 322-m, a providing unit 123-m, a control unit 126-m, and a storage unit 127-m. The secure federated learning device 32-m executes each process on the basis of the control of the control unit 126-m, and input information and information obtained through each process are stored in the storage unit 127-m, and read and used as necessary.

### <Preprocessing>

The preprocessing of the present embodiment is the same as that of the first embodiment.

### <Learning Processing>

The learning processing of the present embodiment will be illustrated below.

First, the model learning device 31-n (FIG. 6) instead of the model learning device 11-n executes the processes of steps S113-n, S114-n, and S115-n described in the first embodiment, and the secure federated learning device 32-m (FIG. 3) instead of the secure federated learning device 12-m executes the process of step S121-m. However, since the control device 13 is not provided in the present embodiment, the providing unit 115-n of the model learning device 31-n does not transmit the above-mentioned synchronization information to the control device 13 in step S115-n.

In addition, the determination unit 328-m of the secure federated learning device 32-m refers to the confidential information [WM-n]ₘ stored in the storage unit 127-m at a predetermined opportunity, and determines whether or not registration of the worker model is completed. For example, the determination unit 328-m may periodically perform the determination, or may perform the determination using the storage of each piece of confidential information [WM-n]ₘ in the storage unit 127-m as a trigger. The completion of the registration of the worker model means that confidential information [WM-n₁]ₘ, . . . , [WM-nₘₐₓ]ₘ of information that specifies a new worker model has been obtained from predetermined model learning devices 31-n₁, . . . , 31-nₘₐₓ (where {n₁, . . . , nₘₐₓ}={1, . . . , N}). That is, the determination unit 328-m determines whether or not confidential information [WM-n₁]ₘ, . . . , [WM-nₘₐₓ]ₘ of information that specifies a new worker model has been obtained from predetermined model learning devices 31-n₁, . . . , 31-nₘₐₓ. The predetermined model learning devices 31-n₁, . . . , 31-nₘₐₓ may be all model learning devices 31-1, . . . , 31-N (that is, {n₁, . . . , nₘₐₓ}={1, . . . , N}), or may be some model learning devices 31-n₁, . . . , 31-nₘₐₓ (that is, {n₁, . . . , nₘₐₓ}⊂{1, . . . , N}) set in advance. Further, the confidential information [WM-n₁]ₘ, . . . , [WM-nₘₐₓ]ₘ of the information that specifies the new worker model may be confidential information [WM-n₁]ₘ, . . . , [WM-nₘₐₓ]ₘ that has not yet been used in the secure aggregation processing, or may be confidential information [WM-n₁]ₘ, . . . , [WM-nₘₐₓ]ₘ acquired after the previous secure aggregation processing. However, since the confidential information [WM-n]ₘ is a share of secure sharing method or ciphertext of homomorphic encryption method, in some cases, it may not be possible to specify the model learning device 31-n that provided the confidential information [WM-n]ₘ from the confidential information [WM-n]ₘ. In such a case, the determination unit 328-m may determine whether or not the registration of the worker model is completed from the total data amount of the confidential information [WM-n]ₘ stored in the storage unit 127-m. For example, when the total data amount of the confidential information [WM-n]ₘ stored in the storage unit 127-m matches the total data amount of confidential information [WM-n₁]ₘ, . . . , [WM-nₘₐₓ]ₘ provided from the predetermined model learning devices 31-n₁, . . . , 31-nₘₐₓ, the determination unit 328-m may determine that the registration of the worker model is completed, and when not, the determination unit 328-m may determine that the registration of the worker model is not completed. Alternatively, when the total number of worker models corresponding to the confidential information [WM-n]ₘ stored in the storage unit 127-m matches the total number of worker models nₘₐₓ of the predetermined model learning devices 31-n₁, . . . , 31-nₘₐₓ, the determination unit 328-m may determine that the registration of the worker model is completed, and when not, the determination unit 328-m may determine that the registration of the worker model is not completed. For example, when information WM-n that specifies a worker model is a model parameter group, the number of model parameters included in one worker model is NMP, and the total data amount of confidential information [WM-n]ₘ stored in the storage unit 127-m is the number of records NR, the total number of worker models provided with confidential information [WM-n]ₘ is N_{R}/N_{MP}. In this case, when nₘₐₓ=N_{R}/N_{MP}, the determination unit 328-m may determine that the registration of the worker model is completed, and when not, the determination unit 328-m may determine that the registration of the worker model is not completed. Here, when it is determined that the registration of the worker model is not completed and it is determined that a predetermined time has not elapsed from the reference point of time (timeout has not occurred), the determination unit 328-m determines again at a predetermined opportunity whether or not registration of this worker model is completed. For example, the determination unit 328-m may perform the determination again after a predetermined waiting time has elapsed, or may perform the determination using the storage of any confidential information [WM-n]ₘ in the storage unit 127-m as a trigger. On the other hand, when it is determined that the registration of the worker model is completed or it is determined that a predetermined time has elapsed from the reference point of time (timeout has occurred), the determination unit 328-m sends a command to instruct the control unit 126-m to start secure aggregation processing. An example of the reference point of time of the timeout is as described in the first embodiment (step S328-m).

Upon receiving the command to instruct the start of the secure aggregation processing, the control unit 126-m instructs the secure aggregation processing unit 322-m to start the secure aggregation processing. Upon receiving this, the secure aggregation processing unit 322-m reads a plurality of pieces of confidential information [WM-n] (where n∈{1, . . . , N}) (confidential information of information that specifies a plurality of worker models) from the storage unit 127-m, and obtains and outputs confidential information [GM]ₘ of information GM that specifies an aggregate model that is an aggregation of the plurality of worker models without obtaining the plurality of worker models through secure computation using the read information (secure aggregation processing). That is, when it is determined that the confidential information [WM-n₁]ₘ, . . . , [WM-nₘₐₓ]ₘ of the information that specifies the worker model has been obtained from the predetermined model learning devices 31-n₁, . . . , 31-nₘₐₓ, the secure aggregation processing unit 322-m obtains and outputs confidential information [GM]ₘ of information GM that specifies an aggregate model that is an aggregation of the plurality of worker models through secure computation using the confidential information [WM-n₁]ₘ, . . . , [WM-nₘₐₓ]ₘ of the information that specifies the worker model. The confidential information [GM]ₘ of the information GM that specifies the aggregate model is sent to the providing unit 123-m (step S322-m).

The acquisition unit 312-n of the model learning device 31-n (FIG. 6) accesses the providing unit 123-m of the secure federated learning device 32-m (where m∈{1, . . . , M}) (FIG. 3) at a predetermined opportunity and acquires the confidential information [GM]ₘ of the information GM that specifies the aggregate model from the providing unit 123-m. The acquisition unit 312-n restores the acquired confidential information [GM]ₘ to obtain information GM that specifies the aggregate model. The information GM that specifies the aggregate model is stored in the storage unit 111-n (step S312-n).

The determination unit 317-n determines whether it is necessary to update the aggregate model corresponding to the information GM stored in the storage unit 111-n to newly obtain a worker model. In other words, the determination unit 317-n determines whether or not it is necessary to update the latest aggregate model specified by the information GM through machine learning using the local learning data D-n to obtain a worker model. For example, when the aggregate model is the same as or approximates the “latest aggregate model” that has already been used to generate the worker model (step S113-n), the determination unit 317-n determines that it is not necessary to update the aggregate model to newly obtain a worker model, and when not, the determination unit 317-n determines that it is necessary to update the aggregate model to newly obtain a worker model. Note that two aggregate models being approximated may mean, for example, that the distance between their model parameters is equal to or less than a predetermined value, or may mean that the difference in the output distributions of the two aggregate models for a predetermined input group is equal to or less than a predetermined value (step S317a-n).

Here, when it is determined that it is not necessary to update the aggregate model to newly obtain a worker model, the control unit 116-n determines whether or not the termination condition for federated learning is satisfied. When the termination condition is satisfied here, the process is terminated. On the other hand, when the termination condition is not satisfied, without the learning unit 113-n updating the aggregate model to newly obtain a worker model, the acquisition unit 312-n acquires confidential information [GM]ₘ of information that specifies a new aggregate model from the secure federated learning device 32-m (where m∈{1, . . . , M}) (FIG. 3) after a waiting time has elapsed. That is, without the learning unit 113-n obtaining a new worker model, the acquisition unit 312-n accesses the providing unit 123-m after the waiting time has elapsed and acquires the confidential information [GM]ₘ of the information GM that specifies the aggregate model from the providing unit 123-m. The acquisition unit 312-n restores the acquired confidential information [GM]ₘ to obtain information GM that specifies the aggregate model, stores the information GM in the storage unit 111-n, and returns to step S317a-n (step S317b-n).

On the other hand, when it is determined that it is necessary to update the aggregate model to newly obtain a worker model, the process returns to step S113-n (step S317c-n). That is, the learning unit 113-n reads the local learning data D-n and the latest information GM stored in the storage unit 111-n, updates the latest aggregate model specified by the information GM through machine learning using the local learning data D-n to obtain a worker model, and outputs information WM-n that specifies the worker model (step S113-n). Thereafter, the processes from step S114-n onwards that have been described so far in the present embodiment are executed again.

### Features of Present Embodiment

Also in the present embodiment, a plurality of model learning devices provide confidential information of information that specifies worker models to a secure federated learning device, and the secure federated learning device obtains confidential information of information that specifies an aggregate model that is an aggregation of the plurality of worker models without obtaining the plurality of worker models using the confidential information. In this case, since the secure federated learning device cannot obtain the worker model itself, the tendency of learning data held by each model learning device cannot be known on the basis of the difference between the worker model and the aggregate model. Thereby, the safety of federated learning can be improved.

Further, the model learning device of the present embodiment determines whether or not it is necessary to update the aggregate model to newly obtain a worker model. Here, when it is determined that it is not necessary to update the aggregate model to newly obtain a worker model, the model learning device acquires confidential information of information that specifies a new aggregate model after a waiting time has elapsed without updating the aggregate model to newly obtain a worker model. On the other hand, when it is determined that it is necessary to update the aggregate model to newly obtain a worker model, the model learning device updates the aggregate model through machine learning using local learning data to obtain a worker model. The secure federated learning device also determines whether or not the confidential information of the information that specifies the worker model has been obtained from a predetermined model learning device. Here, when it is determined that the confidential information of the information that specifies the worker model has been obtained from the predetermined model learning device, the secure federated learning device obtains confidential information of information that specifies an aggregate model that is an aggregation of worker models through secure computation using the confidential information of the information that specifies the worker model. Thereby, the safety of federated learning can be improved without using the control device 13.

Further, in the present embodiment, since the model learning device does not communicate to the outside that it has finished learning of the worker model, the leakage of information on the performance and processing time of each model learning device can be prevented.

### Modification 1 of Third Embodiment

In the third embodiment, when it is determined that the registration of the worker model is completed or it is determined that a predetermined time has elapsed from the reference point of time, the determination unit 328-m of the secure federated learning device 32-m (FIG. 3) sends a command to instruct the control unit 126-m to start secure aggregation processing (step S328-m). However, when the determination unit 328-m determines that the registration of the worker model is completed without determining whether or not a predetermined time has elapsed from the reference point of time, the determination unit 328-m may send a command to instruct the control unit 126-m to start secure aggregation processing.

### Modification 2 of Third Embodiment

In the third embodiment, the acquisition unit 312-n of the model learning device 31-n (FIG. 6) acquires the confidential information [GM]ₘ of the information GM that specifies the aggregate model from the providing unit 123-m of the secure federated learning device 32-m (FIG. 3) at a predetermined opportunity, and restores the acquired confidential information [GM]ₘ to obtain information GM that specifies the aggregate model. However, the acquisition unit 312-n of the model learning device 31-n may acquire the information GM that specifies the aggregate model from the providing unit 223-1 of the specific secure federated learning device 32-1 (FIG. 4) at a predetermined opportunity. In this case, as described in the second embodiment, in step S322-m, the confidential information [GM]₁ of the information GM that specifies the aggregate model is sent to the providing unit 223-1 of the secure federated learning device 32-1 (FIG. 4). Furthermore, in the case of M≥2, the providing unit 323-m′ (where m′∈{2, . . . , M}) of the secure federated learning device 32-m′ further transmits confidential information [GM]ₘ′ to the providing unit 223-1 of the secure federated learning device 32-1 (FIG. 4). Thus, the confidential information [GM]ₘ (where m∈{1, . . . , M}) is input to the providing unit 223-1 of the secure federated learning device 32-1. The providing unit 223-1 restores the input confidential information [GM]ₘ to obtain information GM that specifies the aggregate model. The acquisition unit 112-n of the model learning device 31-n acquires the information GM that specifies the aggregate model from the providing unit 223-1 of the secure federated learning device 32-1 (FIG. 4) at a predetermined opportunity. Others are the same as the third embodiment.

### Fourth Embodiment

The present embodiment is a modification of the third embodiment. In a fourth embodiment, the secure federated learning device is further provided with plain text synchronization information indicating that the model learning device has provided the secure federated learning device with confidential information of information that specifies a worker model. The secure federated learning device acquires plain text synchronization information indicating that the model learning device has provided the secure federated learning device with the confidential information of the information that specifies the worker model, and uses the synchronization information to determine whether or not the confidential information of the information that specifies the worker model has been obtained from a predetermined model learning device. Thereby, communication can be made more efficient and performance can be improved.

### <Configuration>

As illustrated in FIG. 5, a federated learning system 4 of the present embodiment includes N model learning devices 41-1, . . . , 41-N that perform model learning and M secure federated learning devices 42-1, . . . , 42-M that perform federated learning through secure computation.

As illustrated in FIG. 6, a model learning device 41-n of the present embodiment includes a storage unit 111-n, an acquisition unit 412-n, a determination unit 317-n, a learning unit 113-n, a concealment unit 114-n, a providing unit 415-n, and a control unit 116-n. The model learning device 41-n executes each process on the basis of the control of the control unit 116-n, and input information and information obtained through each process are stored in the storage unit 111-n, and read and used as necessary.

As illustrated in FIG. 3, a secure federated learning device 42-m of the present embodiment includes an acquisition unit 421-m, a determination unit 428-m, a secure aggregation processing unit 322-m, a providing unit 423-m, a control unit 126-m, and a storage unit 127-m. The secure federated learning device 42-m executes each process on the basis of the control of the control unit 126-m, and input information and information obtained through each process are stored in the storage unit 127-m, and read and used as necessary.

### <Preprocessing>

The preprocessing of the present embodiment is the same as that of the first embodiment.

### <Learning Processing>

The learning processing of the present embodiment will be illustrated below.

First, the model learning device 41-n (FIG. 6) instead of the model learning device 11-n executes the processes of steps S113-n and S114-n described in the first embodiment.

Confidential information [WM-n] obtained in the process of step S114-n={[WM-n]₁, . . . , [WM-n]_{M}} (confidential information of information WM-n that specifies the worker model) is input to the providing unit 415-n of the model learning device 41-n (FIG. 6). The providing unit 415-n transmits (provides) confidential information [WM-n]ₘ of the information WM-n that specifies the worker model to the secure federated learning device 42-m (FIG. 3) (where m=1, . . . , M). Further, the providing unit 415-n transmits (provides), to the secure federated learning device 42-m, synchronization information syn-n indicating that the model learning device 41-n has transmitted confidential information [WM-n]ₘ of the information WM-n that specifies the worker model to the secure federated learning device 42-m (that the model learning device 41-n has completed learning the worker model) (where m=1, . . . , M). Note that the synchronization information syn-n is plain text (step S415-n).

The acquisition unit 121-m of the secure federated learning device 42-m (FIG. 3) receives confidential information [WM-n]ₘ and synchronization information syn-n sent from the model learning device 41-n, and stores the confidential information [WM-n]ₘ and synchronization information syn-n in the storage unit 127-m. That is, the acquisition unit 421-m acquires confidential information [WM-n]ₘ of the information WM-n that specifies the plurality of worker models from the plurality of model learning devices 41-n and synchronization information syn-n indicating that the model learning device 41-n has transmitted the confidential information [WM-n]ₘ of the information WM-n that specifies the worker models to the secure federated learning device 42-m, and stores them in the storage unit 127-m (step S421-m).

In addition, the determination unit 428-m of the secure federated learning device 42-m uses the synchronization information syn-n stored in the storage unit 127-m at a predetermined opportunity, and determines whether or not registration of the worker model is completed. For example, the determination unit 428-m may periodically perform the determination, or may perform the determination using the storage of each piece of confidential information [WM-n]ₘ and synchronization information syn-n in the storage unit 127-m as a trigger. As described in the third embodiment, the completion of the registration of the worker model means that confidential information [WM-n₁]ₘ, . . . , [WM-nₘₐₓ]ₘ Of information that specifies a new worker model has been obtained from predetermined model learning devices 41-n₁, . . . , 41-nₘₐₓ (where {n₁, . . . , nₘₐₓ}⊆{1, . . . , N}). By using the synchronization information syn-n, the determination unit 428-m can know which model learning device 41-n has provided the confidential information [WM-n]ₘ to the secure federated learning device 42-m. Therefore, by using this synchronization information syn-n, the determination unit 428-m can accurately determine whether or not registration of the worker model is completed. Here, when it is determined that the registration of the worker model is not completed and it is determined that a predetermined time has not elapsed from the reference point of time (timeout has not occurred), the determination unit 428-m determines again at a predetermined opportunity whether or not registration of this worker model is completed. On the other hand, when it is determined that the registration of the worker model is completed or it is determined that a predetermined time has elapsed from the reference point of time (timeout has occurred), the determination unit 428-m sends a command to instruct the control unit 126-m to start secure aggregation processing. An example of the reference point of time of the timeout is as described in the first embodiment (step S421-m).

Upon receiving the command to instruct the start of the secure aggregation processing, the control unit 126-m instructs the secure aggregation processing unit 322-m to start the secure aggregation processing. Upon receiving this, the secure aggregation processing unit 322-m reads a plurality of pieces of confidential information [WM-n] (where n∈{1, . . . , N}) (confidential information of information that specifies a plurality of worker models) from the storage unit 127-m, and obtains and outputs confidential information [GM]ₘ Of information GM that specifies an aggregate model that is an aggregation of the plurality of worker models without obtaining the plurality of worker models through secure computation using the read information (secure aggregation processing). The confidential information [GM]ₘ of the information GM that specifies the aggregate model is sent to the providing unit 423-m (step S322-m).

Confidential information [GM]ₘ is input to the providing unit 423-m. The providing unit 423-m transmits (provides) confidential information [GM]ₘ of information GM that specifies the aggregate model to the model learning device 41-n (step S423-m) as a return value for the confidential information [WM-n]ₘ and the synchronization information syn-n received by the acquisition unit 121-m from the model learning device 41-n (step S421-m).

The confidential information [GM]ₘ provided from the secure federated learning device 42-m (where m∈{1, . . . , M}) is input as a return value to the acquisition unit 412-n of the model learning device 41-n (FIG. 6). The acquisition unit 412-n restores the acquired confidential information [GM]ₘ to obtain information GM that specifies the aggregate model. The information GM that specifies the aggregate model is stored in the storage unit 111-n (step S412-n).

The determination unit 317-n determines whether it is necessary to update the aggregate model corresponding to the information GM stored in the storage unit 111-n to newly obtain a worker model. In other words, the determination unit 317-n determines whether or not it is necessary to update the latest aggregate model specified by the information GM through machine learning using the local learning data D-n to obtain a worker model (step S317a-n).

Here, when it is determined that it is not necessary to update the aggregate model to newly obtain a worker model, the control unit 116-n of the model learning device 41-n (FIG. 6) determines whether or not the termination condition for federated learning is satisfied. When the termination condition is satisfied here, the process is terminated. On the other hand, when the termination condition is not satisfied, without the learning unit 113-n updating the aggregate model to newly obtain a worker model, the acquisition unit 412-n acquires confidential information [GM]ₘ of information that specifies a new aggregate model from the secure federated learning device 42-m (where m∈{1, . . . , M}) (FIG. 3) after the waiting time has elapsed. The acquisition unit 412-n restores the acquired confidential information [GM]ₘ to obtain information GM that specifies the aggregate model, stores the information GM in the storage unit 111-n, and returns to step S317a-n (step S417b-n).

On the other hand, when it is determined that it is necessary to update the aggregate model to newly obtain a worker model, the process returns to step S113-n (step S317c-n). Thereafter, the processes from step S114-n onwards that have been described so far in the present embodiment are executed again.

### Features of Present Embodiment

Also in the present embodiment, a plurality of model learning devices provide confidential information of information that specifies worker models to a secure federated learning device, and the secure federated learning device obtains confidential information of information that specifies an aggregate model that is an aggregation of the plurality of worker models without obtaining the plurality of worker models using the confidential information. In this case, since the secure federated learning device cannot obtain the worker model itself, the tendency of learning data held by each model learning device cannot be known on the basis of the difference between the worker model and the aggregate model. Thereby, the safety of federated learning can be improved.

Further, the model learning device of the present embodiment determines whether or not it is necessary to update the aggregate model to newly obtain a worker model. Here, when it is determined that it is not necessary to update the aggregate model to newly obtain a worker model, the model learning device acquires confidential information of information that specifies a new aggregate model after a waiting time has elapsed without updating the aggregate model to newly obtain a worker model. On the other hand, when it is determined that it is necessary to update the aggregate model to newly obtain a worker model, the model learning device updates the aggregate model through machine learning using local learning data to obtain a worker model. The secure federated learning device also determines whether or not the confidential information of the information that specifies the worker model has been obtained from a predetermined model learning device. Here, when it is determined that the confidential information of the information that specifies the worker model has been obtained from the predetermined model learning device, the secure federated learning device obtains confidential information of information that specifies an aggregate model that is an aggregation of worker models through secure computation using the confidential information of the information that specifies the worker model. Thereby, the safety of federated learning can be improved without using the control device 13.

Further, the model learning device of the present embodiment further provides the secure federated learning device with plain text synchronization information indicating that the model learning device has provided the secure federated learning device with the confidential information of the information that specifies the worker model. The secure federated learning device uses the synchronization information to determine whether or not the confidential information of the information that specifies the worker model has been obtained from a predetermined model learning device. Thus, it is possible to accurately determine whether or not the registration of the worker model is completed. As a result, communication can be made more efficient and performance can be improved.

### Modification 1 of Fourth Embodiment

In the fourth embodiment, when it is determined that the registration of the worker model is completed or it is determined that a predetermined time has elapsed from the reference point of time, the determination unit 428-m of the secure federated learning device 42-m (FIG. 3) sends a command to instruct the control unit 126-m to start secure aggregation processing (step S428-m). However, when the determination unit 428-m determines that the registration of the worker model is completed without determining whether or not a predetermined time has elapsed from the reference point of time, the determination unit 428-m may send a command to instruct the control unit 126-m to start secure aggregation processing.

### Modification 2 of Fourth Embodiment

In the fourth embodiment, the acquisition unit 412-n of the model learning device 41-n (FIG. 6) acquires the confidential information [GM]ₘ of the information GM that specifies the aggregate model from the providing unit 423-m of the secure federated learning device 42-m (FIG. 3) as a return value, and restores the acquired confidential information [GM]ₘ to obtain information GM that specifies the aggregate model. However, the acquisition unit 112-n of the model learning device 31-n may acquire the information GM that specifies the aggregate model from the providing unit 223-1 of the specific secure federated learning device 42-1 (FIG. 4) as a return value. In this case, as described in the second embodiment, in step S322-m, the confidential information [GM]₁ of the information GM that specifies the aggregate model is sent to the providing unit 223-1 of the secure federated learning device 42-1 (FIG. 4). Furthermore, in the case of M≥2, the providing unit 423-m′ (where m′∈{2, . . . , M}) of the secure federated learning device 42-m′ further transmits confidential information [GM]ₘ′ to the providing unit 223-1 of the secure federated learning device 42-1 (FIG. 4). Thus, the confidential information [GM]ₘ (where m∈{1, . . . , M}) is input to the providing unit 223-1 of the secure federated learning device 42-1. The providing unit 223-1 restores the input confidential information [GM]ₘ to obtain information GM that specifies the aggregate model, and transmits the information as a return value to the model learning device 41-n. The acquisition unit 412-n of the model learning device 41-n acquires the information GM that specifies the aggregate model from the providing unit 223-1 of the secure federated learning device 42-1 (FIG. 4) as a return value. Others are the same as the fourth embodiment.

### [Hardware Configuration]

Each of the model learning devices 11-n, 21-n, . . . , 31-n, and 41-n and the secure federated learning devices 12-m, 22-1, 32-m, and 42-m according to the respective embodiments is a device configured with a general-purpose or dedicated computer executing a predetermined program, the computer including a processor (a hardware processor) such as a central processing unit (CPU) and a memory such as a random-access memory (RAM) and a read-only memory (ROM), for example. That is, each of the model learning devices 11-n, 21-n, . . . , 31-n, and 41-n and the secure federated learning devices 12-m, 22-1, 32-m, and 42-m according to the respective embodiments includes, for example, a processing circuit (processing circuitry) configured to implement each unit included in each of the above-mentioned devices. The computer may include one processor and one memory, or may include a plurality of processors and a plurality of memories. The program may be installed into the computer, or may be recorded in a ROM or the like in advance. Also, some or all of the processing units may be configured using an electronic circuit that independently implements the processing functions, rather than an electronic circuit (circuitry) that forms the functional components by reading the program like a CPU. Further, an electronic circuit constituting one device may include a plurality of CPUS.

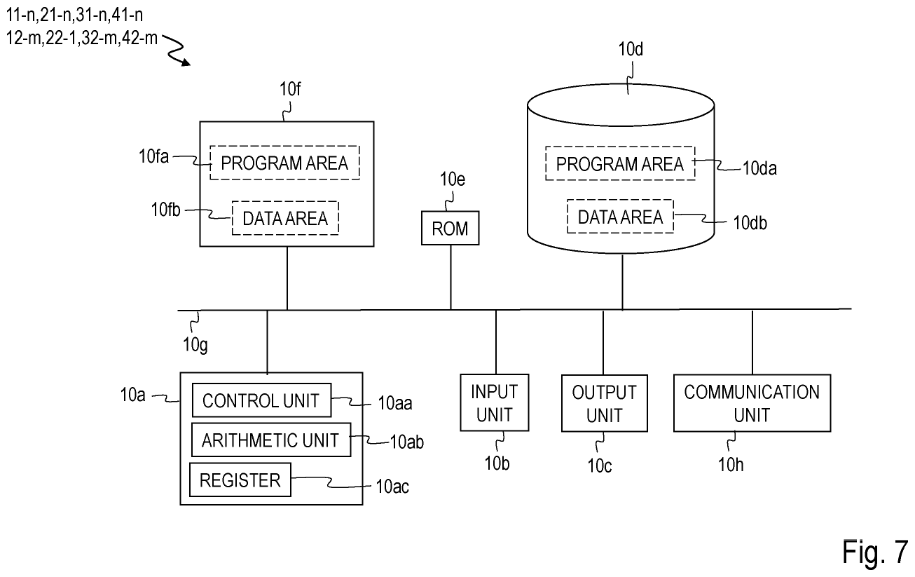

FIG. 7 is a block diagram illustrating a hardware configuration of each of the model learning devices 11-n, 21-n, 31-n, and 41-n and the secure federated learning devices 12-m, 22-1, 32-m, and 42-m according to the respective embodiments. As illustrated in FIG. 7, each of the model learning devices 11-n, 21-n, . . . , 31-n, and 41-n and the secure federated learning devices 12-m, 22-1, 32-m, and 42-m in this example includes a central processing unit (CPU) 10a, an input unit 10b, an output unit 10c, a random access memory (RAM) 10d, a read only memory (ROM) 10e, an auxiliary storage device 10f, a communication unit 10h, and a bus 10g. The CPU 10a in this example includes a control unit 10aa, an arithmetic unit 10ab, and a register 10ac, and executes various arithmetic operations in accordance with various programs read into the register 10ac. The input unit 10b is an input terminal, a keyboard, a mouse, a touch panel, or the like to which data is input. Furthermore, the output unit 10c is an output terminal, a display, or the like from which data is output. The communication unit 10h is a LAN card or the like that is controlled by the CPU 10a has read a predetermined program. The RAM 10d is a static random-access memory (SRAM), a dynamic random-access memory (DRAM), or the like, and incudes a program area 10da in which a predetermined program is stored and a data area 10db in which various types of data are stored. The auxiliary storage device 10f is a hard disk, a magneto-optical disc (MO), a semiconductor memory, or the like, for example, and includes a program area 10fa in which a predetermined program is stored and a data area 10fb in which various types of data are stored. Further, the bus 10g connects the CPU 10a, the input unit 10b, the output unit 10c, the RAM 10d, the ROM 10e, the communication unit 10h, and the auxiliary storage device 10f so that information can be exchanged. The CPU 10a writes, into the program area 10da of the RAM 10d, the program stored in the program area 10fa of the auxiliary storage device 10f in accordance with a read operating system (OS) program. Likewise, the CPU 10a writes various types of data stored in the data area 10fb of the auxiliary storage device 10f into the data area 10db of the RAM 10d. Also, the address on the RAM 10d in which this program or data is written is stored in the register 10ac of the CPU 10a. The control unit 10aa of the CPU 10a sequentially reads these addresses stored in the register 10ac, reads a program or data from the area on the RAM 10d indicated by the read address, causes the arithmetic unit 10ab to sequentially execute the calculations indicated by the program, and stores the calculation result in the register 10ac. With such a configuration, the functional configurations of the model learning devices 11-n, 21-n, . . . , 31-n, and 41-n and the secure federated learning devices 12-m, 22-1, 32-m, and 42-m are implemented.

The program described above can be recorded in a computer-readable recording medium. Examples of the computer-readable recording medium include a non-transitory recording medium. Examples of such recording media are magnetic recording devices, optical discs, magneto-optical recording media, semiconductor memory, and the like.

The distribution of this program is carried out by, for example, selling, transferring, or lending a portable recording medium such as a DVD or a CD-ROM on which the program is recorded. Further, the program may be distributed by storing the program in a storage device of a server computer and transferring the program from the server computer to other computers via a network. As described above, the computer executing such a program first stores a program recorded in a portable recording medium or a program transferred from the server computer temporarily into a storage device of the computer, for example. At the time of execution of a process, the computer reads the program stored in the storage device of the computer, and performs processing in accordance with the read program. As another execution form of the program, a computer may directly read the program from a portable recording medium and execute processing in accordance with the program. Further, whenever the program is transferred from the server computer to the computer, the processing may be executed in order in accordance with the received program. The above-described processing may be executed by a so-called application service provider (ASP) type service that realizes a processing function in accordance with only an execution instruction and result acquisition without transferring the program from the server computer to the computer. Note that the program in the present embodiment includes information that is used for processing by an electronic computer and is equivalent to the program (data or the like that is not a direct command to the computer but has property that defines processing performed by the computer).

Although the device is configured by executing a predetermined program on a computer in each embodiment, at least a part of these processing contents may be implemented by hardware.

### OTHER MODIFICATIONS

The present invention is not limited to the above-described embodiments. For example, in the above-described embodiments, all or some of the model learning devices may finish learning a worker model using a consensus-building method, agree to provide confidential information of information that specifies the worker model to the secure federated learning device, and provide the secure federated learning device with this information. Thus, the secure federated learning device can receive the confidential information of the information that specifies the worker models of all or some of the model learning devices, and then obtain confidential information of information that specifies an aggregate model that is an aggregation of the worker models.

Also, various kinds of processing described above may be executed not only in time series in accordance with the description but also in parallel or individually in accordance with processing capabilities of the devices that execute the processes or as necessary. In addition, it goes without saying that changes can be made as appropriate without departing from the spirit of the present invention.

### REFERENCE SIGNS LIST

1 to 4 Federated learning system
11-n, 21-n, . . . , 31-n, 41-n Model learning device
111-n Storage unit
112-n, 212-n, 312-n, 412-n Acquisition unit
113-n Learning unit
114-n Concealment unit
115-n, 415-n Providing unit
317-n Determination unit
12-m, 22-1, 32-m, 42-m Secret federated learning device
121-m, 421-m Acquisition unit
122-m, 322-m Secret aggregation processing unit
123-m, 223-1, 423-m Providing unit
127-m Storage unit
328-m, 428-m Determination unit

1. A model learning device comprising:
a storage configured to store local learning data; and
processing circuitry configured to:
obtain information that specifies an aggregate model or confidential information of the information that specifies the aggregate model from a secure federated learning device;
update the aggregate model through machine learning using the local learning data to obtain a worker model;
obtain confidential information of information that specifies the worker model; and
provide the confidential information of the information that specifies the worker model to the secure federated learning device.

2. The model learning device according to claim 1, wherein the processing circuitry is further:
configured to determine whether or not it is necessary to update the aggregate model to newly obtain the worker model, wherein
when it is determined that it is not necessary to update the aggregate model to newly obtain the worker model, without updating the aggregate model to newly obtain the worker model, the processing circuitry acquires information that specifies a new aggregate model or confidential information of the information that specifies the new aggregate model from the secure federated learning device after a waiting time has elapsed, and when it is determined that it is necessary to update the aggregate model to newly obtain the worker model, the processing circuitry updates the aggregate model through machine learning using the local learning data to obtain the worker model.

3. The model learning device according to claim 1, wherein the processing circuitry further provides the secure federated learning device with plain text synchronization information indicating that the model learning device has provided the secure federated learning device with the confidential information of the information that specifies the worker model.

4. A secure federated learning device comprising processing circuitry configured to:
obtain confidential information of information that specifies a plurality of worker models from a plurality of model learning devices;
obtain confidential information of information that specifies an aggregate model that is an aggregation of the plurality of worker models without obtaining the plurality of worker models through secure computation using the confidential information of the information that specifies the plurality of worker models; and
provide the information that specifies the aggregate model or the confidential information of the information that specifies the aggregate model to the plurality of model learning devices.

5. The secure federated learning device according to claim 4, wherein the processing circuitry is further
configured to determine whether or not the processing circuitry has obtained the confidential information of the information that specifies the worker model from a predetermined model learning device,
wherein, when it is determined that the confidential information of the information that specifies the worker model has been obtained from the predetermined model learning device, the processing circuitry obtains the confidential information of the information that specifies the aggregate model that is an aggregation of the worker models through secure computation using the confidential information of the information that specifies the worker model.

6. The secure federated learning device according to claim 5, wherein the processing circuitry
acquires plain text synchronization information indicating that the model learning device has provided the secure federated learning device with the confidential information of the information that specifies the worker model, and
uses the synchronization information to determine whether or not the confidential information of the information that specifies the worker model has been obtained from the predetermined model learning device.

7. A model learning method using a model learning device, the method comprising:
obtaining information that specifies an aggregate model or confidential information of the information that specifies the aggregate model from a secure federated learning device;
updating the aggregate model through machine learning using local learning data stored in a storage to obtain a worker model;
obtaining confidential information of information that specifies the worker model; and
providing the confidential information of the information that specifies the worker model to the secure federated learning device.

8. A secure federated learning method using a secure federated learning device, the method comprising:
obtaining confidential information of information that specifies a plurality of worker models from a plurality of model learning devices;
obtaining confidential information of information that specifies an aggregate model that is an aggregation of the plurality of worker models without obtaining the plurality of worker models through secure computation using the confidential information of the information that specifies the plurality of worker models; and
providing the information that specifies the aggregate model or the confidential information of the information that specifies the aggregate model to the plurality of model learning devices.

9. A non-transitory computer-readable recording medium storing a program for causing a computer to function as the model learning device according to claim 1.

10. A non-transitory computer-readable recording medium storing a program for causing a computer to function as the secure federated learning device according to claim 4.
